(19) United States
(12) Patent Application Publication
(10) Pub. No.: US 2026/0319499 A1
(43) Pub. Date: Oct. 15, 2026

(54) MULTI-REVOLUTION LAMBERT SOLVER

(71) Applicant: Raytheon Company, Arlington, VA (US)

(72) Inventor: Darin C. Koblick, Rancho Palos Verdes, CA (US)

(21) Appl. No.: 19/241,119

(22) Filed: Jun. 17, 2025

Related U.S. Application Data
(60) Provisional application No. 63/788,559, filed on Apr. 14, 2025.

(51) Int. Cl. G05D 1/46; G05D 109/40

(52) U.S. Cl. CPC G05D 1/46; G05D 2109/40

(57) ABSTRACT

Systems, devices, methods, and computer-readable media for space vehicle maneuvering between an initial point and a final point. A method can include determining, based on an initial position vector, a final position vector, a time of flight between the initial position and the final position, and a transfer direction, a shape of the trajectory and a maximum number of revolutions, identifying upper and lower bounds of the trajectory resulting in identified bounds, iteratively determining, based on the identified bounds, a root of the trajectory using a 4^{th} order Householder root-finding operation, determining, based on the root, velocity vectors indicating velocities required to traverse from the initial point to the final point along the trajectory, and communicating maneuver commands to the space vehicle, the maneuver commands cause the space vehicle to travel from the initial point to the final point using the velocity vectors.

### CLAIM OF PRIORITY

This application claims benefit to U.S. Provisional Patent Application No. 63/788,559, filed Apr. 14, 2025, which is hereby incorporated by reference herein in its entirety.

### BACKGROUND

In celestial mechanics, Lambert's problem is concerned with the determination of an orbit from two position vectors and the time of flight. Lambert's problem was posed in the 18th century by Johann Heinrich Lambert and formally solved with mathematical proof by Joseph-Louis Lagrange. Solutions to Lambert's problem have applications in the areas of rendezvous, targeting, guidance, and preliminary orbit determination.

### BRIEF DESCRIPTION OF DRAWINGS

FIG. 1 illustrates, by way of example, a diagram of an orbital transfer scenario and corresponding variables.

FIG. 2 illustrates, by way of example, a graph of the parametric curves for various N values and for various σ values for each of the various N values.

FIG. 3 illustrates, by way of example, a diagram of an embodiment of method 3 for an iterative Householder 4^{th} order solution update with clamping.

FIG. 4 illustrates, by way of example, a diagram of an embodiment of a method for solving Lambert's problem using the method of FIG. 3.

FIG. 5 illustrates, by way of example, a diagram of an embodiment of performing two of the operations of FIG. 4.

FIG. 6 illustrates, by way of example, graphs of the errors of the prograde and retrograde transfer simulations for direct transfer cases.

FIG. 7 illustrates, by way of example, graphs of the errors of the prograde and retrograde transfer simulations for multi-revolution transfer cases.

FIG. 8 illustrates, by way of example, a diagram of an embodiment of a method for space vehicle management using a fourth-order Householder with clamping.

FIG. 9 illustrates, by way of example, a block diagram of an embodiment of a machine in the example form of a computer system within which instructions, for causing the machine to perform any one or more of the methodologies discussed herein, may be executed.

### DETAILED DESCRIPTION

The following description and the drawings sufficiently illustrate teachings to enable those skilled in the art to practice them. Other embodiments may incorporate structural, logical, electrical, process, and other changes. Portions and features of some examples may be included in, or substituted for, those of other examples. Teachings set forth in the claims encompass all available equivalents of those claims.

Lambert's problem can have multiple solutions for the same positions and time-of-flight, particularly for multi-revolution orbits. This application refines Fang-Toh Sun's 1979 transcendental Lambert equations to solve these solutions robustly and efficiently. By integrating a bounded version of Householder's Fourth Order root-finding method, embodiments systematically clamp the solution to Lambert's function and find all possible roots.

For elliptical orbits, two roots on either side of a local extremum are identified and easily separated using derivative-based checks. This disclosure includes a derivation of an analytical solution for parabolic orbits and bounded hyperbolic solutions within [0, 1] for efficient detection of sign changes. Comprehensive testing across millions of challenging elliptical, parabolic, and hyperbolic scenarios demonstrated that the fourth-order implementation of Householder's method requires fewer function calls and less computations compared to existing methods, including bisection, ridders, Laguerre, and Halley's.

The algorithm for solving Lambert's problem ensures reliable convergence in all cases, fulfilling near real-time requirements for collision avoidance, debris mitigation, and space traffic management. This robust, efficient approach substantially enhances space domain awareness applications by quickly determining optimal maneuvers and improving orbit determination accuracy. Embodiments addresses critical space domain awareness (SDA) challenges effectively.

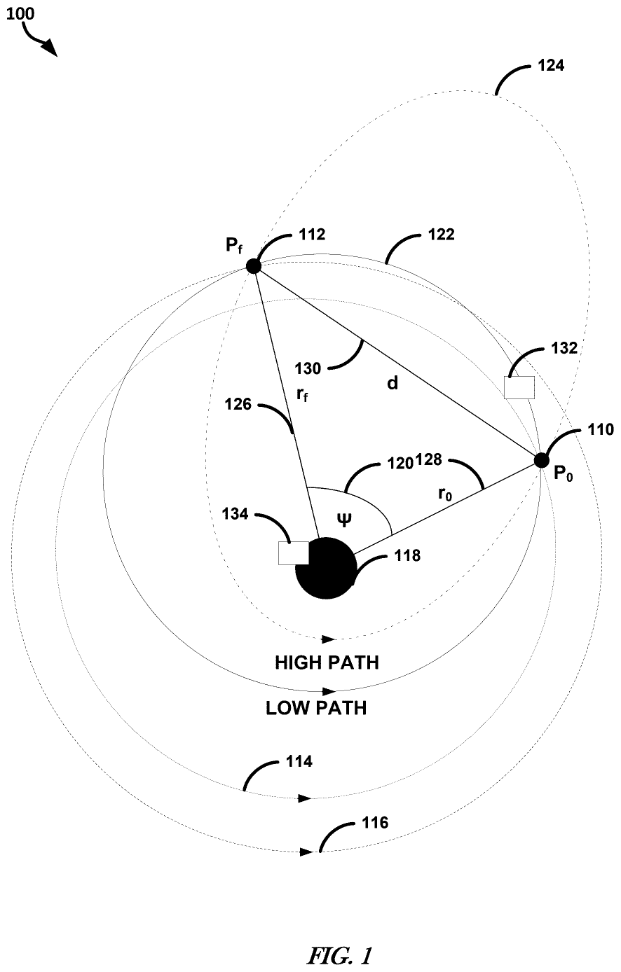

FIG. 1 illustrates, by way of example, a diagram of an orbital transfer scenario 100 and corresponding variables. The orbital transfer scenario 100 includes a space vehicle 132 transferring from an initial position 110, P₀. A goal of the space vehicle 132 (e.g., a satellite, flyby, orbiter, lander, rover, penetrator, observatory, manned spacecraft, or the like) is to transfer to a final position 112, Pf. The initial position 110 and the final position 112 are on different respective orbits 114, 116 about a central body 118. There are multiple paths that the space vehicle 132 can maneuver through to get from the initial position 110 to the final position 112. Two of these paths are illustrated as a high-path 124 and a low-path 122.

The space vehicle 132 can include a communication, remote sensing (e.g., weather, electromagnetic sensing, radar, lidar, or the like), navigation (e.g., global positioning system (GPS), Galileo, or the like), internet, radio, television, manned, unmanned, or other space vehicle. The space vehicle 132 is generally any device capable of communication with a ground station 134 situated on the central body. The space vehicle 132 can be orbiting the Earth, whether in low Earth orbit (LEO), medium Earth orbit (MEO), or high Earth orbit (HEO) or could be a naturally occurring celestial body external to the Earth.

The space vehicle 132 includes antennae that can convert modulated electrical signals to an electromagnetic wave that is transmitted to the ground station 134. The data modulated onto the wave can include Keplerian element data, or equivalent navigational content or a time as provided by a clock.

Locations of the space vehicle 132 can be determined using tracking from the ground station 134. The ground station 134 uses mechanisms, such as radar, signal Doppler, and laser reflectors or measurement of time delay in a time-tagged signal received passively to pinpoint the position of a space vehicle and to maintain an understanding of its orbital elements. Given Keplerian orbital elements, or the equivalent representation of spatiotemporal position, orbital mechanics can be used to calculate where the space vehicle 132 is at a specific point in time, which may be instantiated by a multi-lateration performed by user equipment. The Keplerian elements are: epoch time that indicates the time at which the other values, inclination that indicates the angle between the equator and the orbit plane, eccentricity which is a constant defining the shape of the orbit (e.g., 0=circular, <1=elliptical), length of semi-major axis that is a constant defining the size of the orbit, true anomaly which indicates the angle between perigee and the space vehicle 102 (in the orbit plane), right ascension of the ascending node, the angle between vernal equinox and the point where the orbit crosses the equatorial plane (going north), and argument of perigee that indicates the angle between the ascending node and the orbit's point of closest approach to the earth (perigee). This information can be tabulated in an ephemeris (a table).

Additionally, or alternatively, trilateration can be used by the ground station 134 to determine the position of the space vehicle 132. The ground station 134 can each receive a communication from the space vehicle 132 or transmit a communication to the space vehicle 132. A time between the transmission of communication to/from the space vehicle 132 and reception of the communication to/from the ground station 134 can indicate how far away the space vehicle 132 is from the ground station 134. The distance to the ground station 134 can be used to determine the position of the space vehicle 132. This technique of space vehicle position determination tends to be more accurate than the determination using the Keplerian elements.

The ground station 134 includes a transceiver and an antenna, or other communications circuitry. The transceiver modulates data to be provided to the ground station 134 and receive electrical signals from the space vehicle 132. The data to the space vehicle 132 can indicate how to transfer from the initial position 110 to the final position 112. The data can indicate when and how much to accelerate to achieve the transfer.

The ground station 134 acts as a data processing center for information to/from the space vehicles 132. Orbit coordinates can be determined by trilateration and the orbit model (ephemeris). When the space vehicle drifts out of expected orbit, or a transfer is otherwise beneficial, repositioning can be undertaken. The computed corrections and repositioning information can be transmitted to the space vehicle 132 via an uplink from the ground station 134.

Some variables that are used in solving Lambert's problem are illustrated in FIG. 1 and include a transfer angle 120, ψ, between the initial position 110 and the final position 112. The variables further include an initial position vector 128, r₀, and a final position vector 126, r_{f}. The variables further include a distance 130 between the initial position 110 and the final position 112.

Consider the two-body equations of motion, which depend upon the standard gravitational constant, μ, and two positions, Q₁ and Q₂ described by their cartesian position vectors \vec{r}₁ and \vec{r}₂ with their origin at the center of a central body (e.g., Earth). Let Δt be the time of flight between them and consider dimensionless variables:

$$τ = 4 Δ t \sqrt{μ / {m}^{3}} \qquad Equation 1$$

$${X}^{2} = 1 - m / 4 a \qquad Equation 2$$

$${Y}^{2} = 1 - n / 4 a \qquad Equation 3$$

where m=r₁+r₂+l, n=r₁+r₂−l and

$$l = \vert {\vec{r}}_{1} - {\vec{r}}_{2} \vert ,$$

and a is the semi-major axis of the transfer trajectory, positive for ellipses, infinite for parabolas, and negative for hyperbolas. Lambert's formula may then be written as Equation 4:

$$τ = \{ \begin{matrix}{( 1 - {X}^{2} )}^{- \frac{3}{2}} \{ {cot}^{- 1} [ f ( X ) ] - {cot}^{- 1} [ f ( Y ) ] - {f}^{*} ( X ) + {f}^{*} ( Y ) + N π \} , \\ \vert X \vert < 1 ( ellipse ) \\ {( {X}^{2} - 1 )}^{- \frac{3}{2}} \{ - {coth}^{- 1} [ g ( X ) ] + {coth}^{- 1} [ g ( Y ) ] + {g}^{*} ( X ) - {g}^{*} ( Y ) \} , \\ X > 1 ( hyperbola ) \\ \frac{2}{3} ( 1 - {σ}^{3} ) \\ X = 1 ( parabola )\end{matrix}$$

where N is the number of revolutions in addition to the direct transfer path connecting Q₁ and Q₂, the parameter functions are defined as f(z)=z/\sqrt{1−z²} and f*(z)=f(z)(1−z²), g(z)=z/\sqrt{z²−1}, and g*(z)=g(z)/(z²−1). The inverse circular functions are contained by:

$$0 \leq {cot}^{- 1} [ f ( X ) ] \leq + π \qquad Equation 5$$

$$- π / 2 \leq {cot}^{- 1} [ f ( Y ) ] \leq + π / 2 \qquad Equation 6$$

where Y is a piecewise function of σ, the signed configuration parameter, and X such that

$$Y = \pm \sqrt{1 - {σ}^{2} ( 1 - {X}^{2} )} \qquad Equation 7$$

Note that the sign for Y is chosen based on a unit step function of σ which can be found from σ²=n/m and is related to r₁ and r₂ and the transfer angle, ψ between the two positions by

$${σ}^{2} = 4 {r}_{1} {r}_{2} / {m}^{2} {cos}^{2} ( \frac{ψ}{2} ) , 0 \leq ψ \leq π \qquad Equation 8$$

σ is related to the variables X and Y by σ²=(1−Y²)/(1−X²) and its sign is selected according to the net range angle ψ_{NR} such that

$$0 < σ \leq 1 , π > {ψ}_{NR} \geq 0 \qquad Equation 9$$

$$σ = 0 , {ψ}_{NR} = π \qquad Equation 10$$

$$- 1 \leq σ < 0 , 2 π \geq {ψ}_{NR} > π \qquad Equation 11$$

It is known that Equation 4 covers all possible cases of orbital flight between Q₁ and Q₂ when σ∈[−1, +1], X∈(−1, ∞) N∈[0, 1, 2, . . . ].

Note that the elliptical and hyperbolic Lambert functions in Equation 4 can be further simplified to a single inverse trigonometric function, atan or atan 2, without any change of variables, as in Equation 12:

$$\{ \begin{matrix}\begin{matrix}{( 1 - {X}^{2} )}^{- \frac{3}{2}} \{ \begin{matrix}a tan 2 [ \frac{{Yf}^{*} ( X )}{X} - \frac{{Xf}^{*} ( Y )}{Y} , XY + \frac{{f}^{*} ( X ) {f}^{*} ( Y )}{XY} ] - \\ {f}^{*} ( X ) + {f}^{*} ( Y ) + [ N + H ( - Y ) ] π\end{matrix} \} , \\ \vert X \vert < 1 ( ellipse )\end{matrix} \\ {( {X}^{2} - 1 )}^{- \frac{3}{2}} \{ \begin{matrix}a tan [ \frac{{g}^{- 1} ( Y ) - {g}^{- 1} ( X )}{1 - {g}^{- 1} ( X ) {g}^{- 1} ( Y )} ] + \\ {g}^{*} ( X ) - {g}^{*} ( Y )\end{matrix} \} , X > 1 ( hyperbola )\end{matrix}$$

where H(−Y) is a Heaviside step function. The first through fourth derivatives of Lambert's formula (applicable to
all transfer trajectory types) with respect to X are computed analytically and depicted in compact form via Equations 13-16:

$$\frac{\partial τ}{\partial X} = ( {f ( X )}^{2} / {X}^{2} ) ) ( 3 τ X - 2 + 2 \vert σ \vert \frac{\partial Y}{\partial X} ) \qquad Equation 13$$

$$\frac{{\partial }^{2} τ}{\partial {X}^{2}} = ( {f ( X )}^{2} / {X}^{2} ) ) ( 3 τ + 5 X \frac{\partial τ}{\partial X} + 2 ( 1 - {σ}^{2} ) \vert {σ}^{3} \vert / {Y}^{3} ) \qquad Equation 14$$

$$Equation 15$$

$$\frac{{\partial }^{3} τ}{\partial {X}^{3}} = ( {f ( X )}^{2} / {X}^{2} ) ) ( 7 X \frac{{\partial }^{2} τ}{\partial {X}^{2}} + 8 \frac{\partial τ}{\partial X} - 6 ( 1 - {σ}^{2} ) \vert {σ}^{3} \vert / {Y}^{4} \frac{\partial Y}{\partial X} )$$

$$Equation 16$$

$$\frac{{\partial }^{4} τ}{\partial {X}^{4}} = ( {f ( X )}^{2} / {X}^{2} ) ) ( 9 X \frac{{\partial }^{3} τ}{\partial {X}^{3}} + 15 \frac{{\partial }^{2} τ}{\partial {X}^{2}} + 6 ( 1 - {σ}^{2} ) \vert {σ}^{3} \vert / {Y}^{5} [ 5 {( \frac{\partial Y}{\partial X} )}^{2} - {σ}^{2} ] )$$

where

$$\frac{\partial Y}{\partial X} = {σ}^{2} X / Y .$$

For the elliptic case, the transfer trajectory can be classified into three path types as follows:

$$0 < X < 1 , low path$$

$$X = 0 , minimum energy path$$

$$- 1 < X < 0 , high path$$

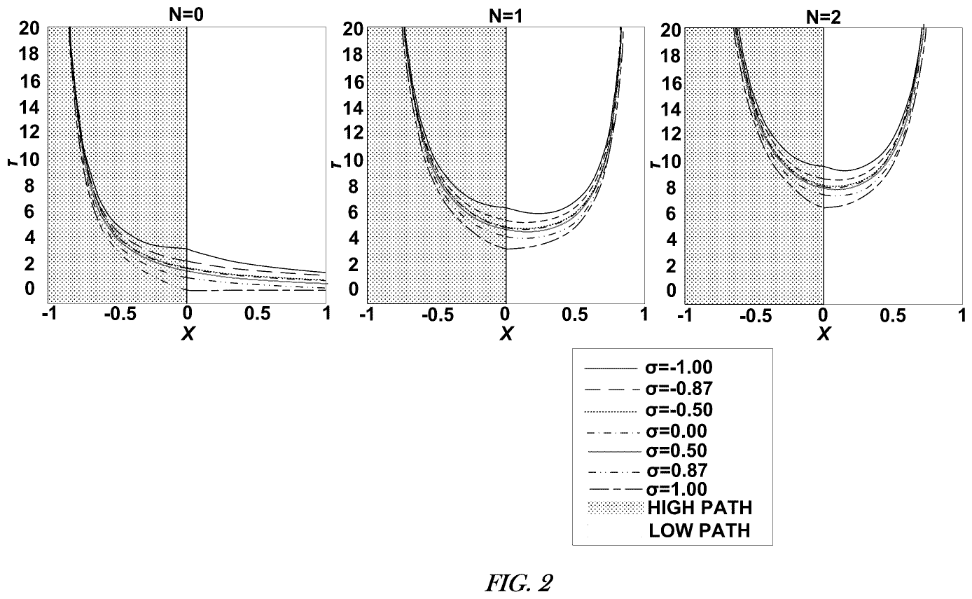

Given all possible conditions for σ and X, complete parametric curves for the elliptic transfer cases were generated for N=0, N=1, and N=2. The parametric curves are illustrated in FIG. 2.

FIG. 2 illustrates, by way of example, a graph of the parametric curves for various N values and for various σ values for each of the various N values. Note that the minimum energy path for any elliptic transfer occurs when X=0.

Equation 4 can be simplified, given the minimum energy path. The minimum energy value for τ is thus governed by Equation 17:

$${τ}_{ME} = {cos}^{- 1} σ + {f}^{*} ( σ ) + N π$$

Minimum energy time of flight can be used to determine the lower bound on the high-path side. After the minimum energy value has been computed for the direct transfer case (e.g., N=0), each subsequent revolution is an addition of another π. Note that the time of flight associated with the minimum energy is not necessarily equal to the minimum time of flight for the low path side. To determine the global minimum time of flight, τ_{*}, for the multi-revolution one can determine the X_{*} value that corresponds to the zero crossing of Equation 13, and plug it back into the elliptical Lambert function as in Equation 12 as:

$$0 = 3 {τ}_{*} {X}_{*} {Y}_{*} - 2 {Y}_{*} + 2 \vert {σ}^{3} \vert {X}_{*} \qquad Equation 18$$

The low-path side for the direct transfer case has a lower bound which approaches that of a parabola X→1 as shown in Equation 19:

$${τ}_{p} = 2 / 3 ( 1 - {σ}^{3} )$$

Regarding the hyperbolic orbit transfers, one can use a change of variable, U=1/X, to bound Lambert's function to exist within U∈(0,1). Analytic bounds for the high path elliptical Lambert transfers can be found from substituting σ=+1 into Equation 12 such that

$${τ}_{U B} = \{ \begin{matrix}{( 1 - {X}^{2} )}^{- \frac{3}{2}} π ( N + 1 ) , X \leq 0 \\ {( {X}^{2} - 1 )}^{- \frac{3}{2}} π , 0 \leq X \leq 1\end{matrix} \qquad Equation 20$$

Note that a lower bound equation, τ_{LB}, is related to the upper bound Equation 20, τ_{UB}, by a shift of pi, τ_{LB}=τ_{UB}−π.

The above equations can be re-arranged to solve for X, providing the upper and lower bounds for a bracketed root finding method. Note that Equation 21 is valid for all Lambert transfer cases. For the case where N=0 and 0≤X≤+1, a quartic polynomial equation is used to model the σ=−1 upper bound, hyperbolic cases are bounded using a cubic polynomial equation as in Equation 21:

$$( {X}_{LB} , {X}_{UB} ) = \{ \begin{matrix}- \sqrt{1 - {( \frac{π ( N + 1 )}{τ + π} )}^{\frac{2}{3}}} , - \sqrt{1 - {( \frac{π ( N + 1 )}{τ} )}^{\frac{2}{3}}} , X \leq 0 ( elliptic high path ) \\ \sqrt{1 - {( \frac{π ( N )}{τ - π} )}^{\frac{2}{3}}} , \sqrt{1 - {( \frac{π ( N )}{τ} )}^{\frac{2}{3}}} , else if N > 0 ( elliptic low path ) \\ 0 , 0.052538 {τ}^{4} - 0.057178 {τ}^{3} + 2.4504 {τ}^{2} - 5.1995 τ + 4.7639 , \\ else if X < 1 ( elliptic low path ) \\ 1 , {( 0.131 {τ}^{3} + 0.000351 {τ}^{2} + 0.51645 τ )}^{- 1} , else ( hyperbolic )\end{matrix}$$

Previous work on Lambert solvers has often made use of Laguerre² or Halley second order iterative methods to solve the transcendental equations presented in Equation 12. Now that both lower and upper bounds are derived for each transfer case, a fourth-order Householder iterative scheme with root clamping to mitigate any risks where a root could jump between high-path and low-path solutions is provided.

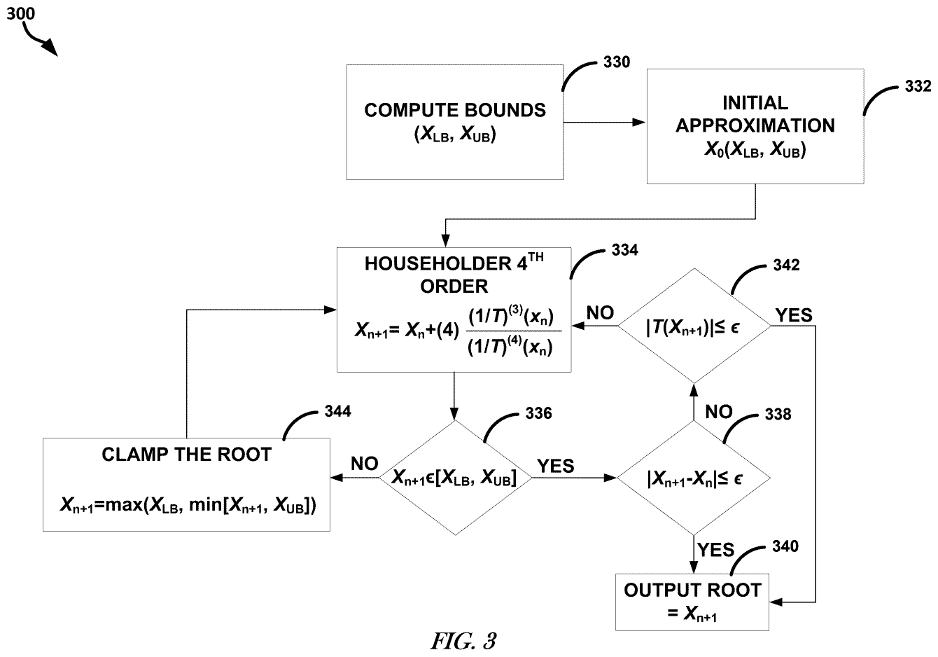

FIG. 3 illustrates, by way of example, a diagram of an embodiment of method 300 for an iterative Householder 4^{th} order solution update with clamping.

The exact form of the fourth-order Householder update iteration is provided in Equation 22:

$${x}_{n + 1} = {x}_{n} + ( 24 {T}^{( 1 )} ( {x}_{n} ) {T}^{( 2 )} ( {x}_{n} ) {T ( {x}_{n} )}^{- 1} - 24 {{T}^{( 1 )} ( {x}_{n} )}^{3} {T ( {x}_{n} )}^{- 2} - 4 {T}^{( 3 )} ( {x}_{n} ) ) / ( {T ( {x}_{n} )}^{- 1} [ 8 {T}^{( 3 )} ( {x}_{n} ) {T}^{( 1 )} ( {x}_{n} ) + 6 {{T}^{( 2 )} ( {x}_{n} )}^{2} ] - 36 {{T}^{( 1 )} ( {x}_{n} )}^{2} {T}^{( 2 )} ( {x}_{n} ) {T ( {x}_{n} )}^{- 2} + 24 {{T}^{( 1 )} ( {x}_{n} )}^{4} {T ( {x}_{n} )}^{- 3} - {T}^{( 4 )} ( {x}_{n} ) )$$

where T⁽¹⁾, T⁽²⁾, T⁽³⁾, and T⁽⁴⁾ represent the first, second, third and fourth derivatives of the Lambert equation respectively, see Equations 13-16. In this case, T(xₙ)=τ(xₙ)−τ*, where τ* is the dimensionless time of flight as found from Equation 1, and τ(xₙ) is computed with Equation 12.

At operation 330, upper and lower bounds for paths between the initial position and the final position are determined, such as by Equation 21. At operation 332, an initial approximation of a path is determined based on the upper and lower bounds determined at operation 330. An appropriate initial approximation can be found from averaging the lower and upper bounds such that x₀=0.5(X_{LB}+X_{UB}).

At operation 334, the Householder 4^{th} order update, from Equation 22, can be applied to the initial approximation. After every iteration of performing the operation 334, one can check if the solution is remaining within the established bounds, xₙ₊₁∈[X_{LB}, X_{UB}], at operation 336. If the resulting solution is outside of the bounds, then it can be clamped, at operation 344, to the closest bound and the operation 334 can be performed again using one of the bounds.

If the resulting solution is within the bounds, convergence is achieved when either the relative or absolute errors are within a specified tolerance, ϵ, such that |xₙ₊₁−xₙ|≤ϵ or |T(xₙ₊₁)|≤ϵ. Determining whether the relative error is within the specified tolerance occurs at operation 338. Determining whether the absolute error is within the specified tolerance occurs at operation 342. If the relative or absolute error is within the specified tolerance, the root of the solution can be output at operation 340. If neither of the relative nor absolute errors are within the specified tolerance, another iteration of the operation 334 can be performed based on the updated root. Note that while this method depicts the fourth-order householder iteration, one can use a third-order for finding the zero crossing in Equation 18.

### Complete Lambert Solver Algorithm

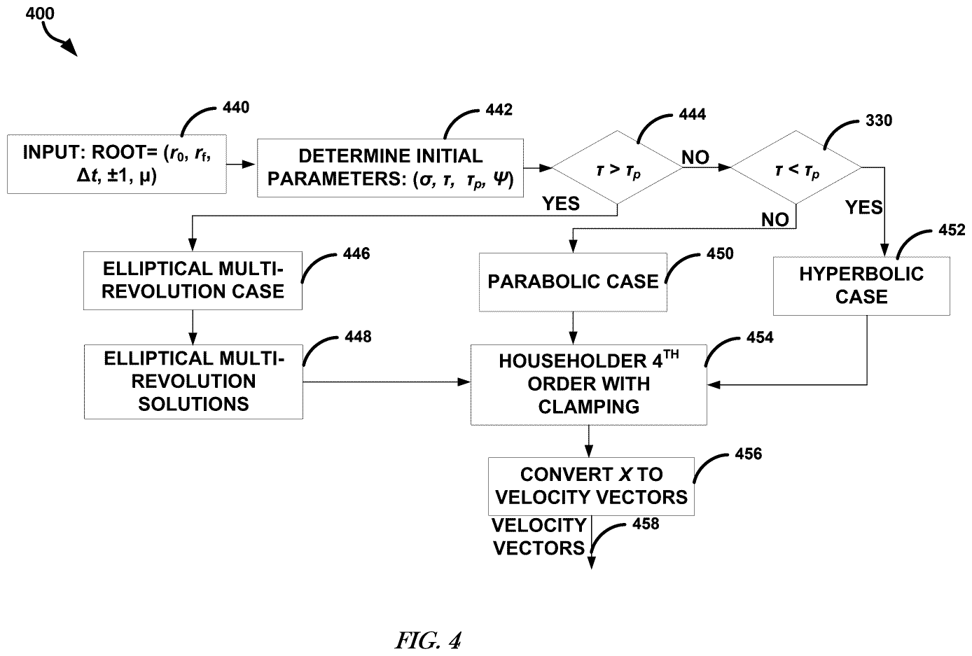

FIG. 4 illustrates, by way of example, a diagram of an embodiment of a method 400 for solving Lambert's problem using the method 300 of FIG. 3. The method 400 includes receiving user input at operation 440. The user input can include initial and final position vectors,

$${\vec{r}}_{1} and {\vec{r}}_{2}$$

as well as time of flight between the two positions, Δt, the standard gravitational parameter of the central body, μ, and a transfer direction indicating prograde or retrograde (e.g., ±σ).

The inputs provided by operation 440 are converted to dimensionless variables, τ, σ, and τₚ at operation 442. The operation 442 can apply Equations 1, 8, and 19 to the inputs.

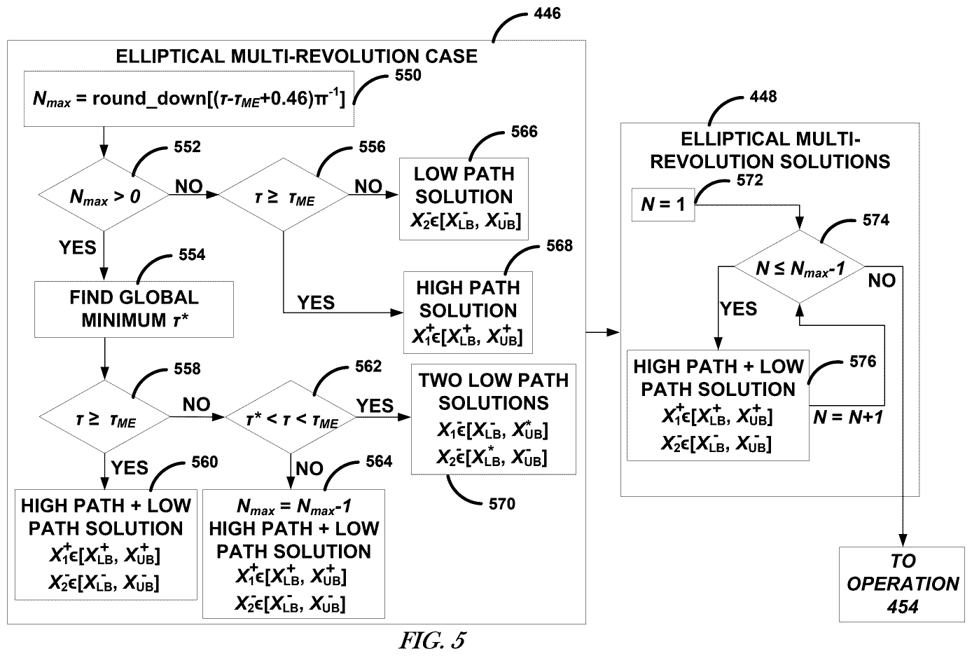

At operation 444 a lower bound of a low-side path, τₚ from Equation 19, is compared to the current approximation, τ. If τ>τₚ then this is an elliptical transfer trajectory that could have multiple revolutions. Operation 446 is then performed on the approximation to determine bounds for the solutions. Then operation 448 is performed to iterate N and check whether the solution is within the determined bounds. More details regarding the operations 446, 448 are provided in FIG. 5 and described now. The remainder of FIG. 4 is described after the description of FIG. 5.

FIG. 5 illustrates, by way of example, a diagram of an embodiment of performing the operations 446 and 448 of FIG. 4. At operation 550, a maximum possible number of revolutions, Nₘₐₓ, is determined. Nₘₐₓ can be determined as Nₘₐₓ=round down(τ−τ_{ME}_{₀}+0.46)τ⁻¹).

At operation 552, the maximum possible number of revolutions is compared to 0. If Nₘₐₓ is greater than 0, the global minimum, τ*, is found for the last revolution, at operation 554. In performing the operation 554, the root, X*, of Equation 18 can be found via a third-order Householder iteration method with clamping between X*∈[0,0.5], and the corresponding minimum time can be computed from Equation 12.

At operation 558, τ can be compared to the τ corresponding to a minimum energy path, τ_{ME}. If τ≥τ_{ME} then there is one high-path and one low-path solution which are provided at operation 560. The two sets of bounds determined at operation 560 can be determined from Equation 21 setting X₁≤0 and X₂>0.

If τ is not greater than (or equal to) τ_{ME} then τ is compared to τ* as well, at operation 562. If τ*<τ<τ_{ME} then there are two low-path solutions which can be bounded by X₁∈[X_{LB}, X*] and X₂∈[X*, X_{UB}] which can be provided at operation 570. If τ*>τ, then Nₘₐₓ can be decremented, by one, at operation 564 such that Nₘₐₓ=Nₘₐₓ−1 and there are two solutions consisting of one high-path and one low-path case, the bounds of which can be provided.

If Nₘₐₓ=0 (it is determined that Nₘₐₓ is not greater than zero at operation 552), then this is a direct Lambert transfer and there is only one possible solution. To determine whether it is a low path solution or a high path solution, τ is compared to τ_{ME} at operation 556. If τ>τ_{ME} then this is an elliptical transfer with a single high-path solution. Equation 21 can used to compute the bounds for X≤0 at operation 568. Else if τ<τ_{ME} then there is a single low-path solution bounded by Equation 21 with X<1 and N=0. The bounds can be determined and provided at operation 566.

If Nₘₐₓ≥0 then there are 2Nₘₐₓ+1 solutions, the bounds of two of which were already previously computed for the revolution corresponding to Nₘₐₓ. The operation 448 provides the bounds for the remaining 2Nₘₐₓ solutions. N is set to one at operation 572 because one set of bounds has already been determined. At operation 574, N is compared to Nₘₐₓ−1. If N is less than, or equal to, Nₘₐₓ−1, there are more bounds to be determined. Those bounds are determined at operation 576. N is incremented by one and re-compared to Nₘₐₓ−1 again. If N is greater than Nₘₐₓ−1, the method 400 continues at operation 454, by performing 4^{th} order Householder with clamping.

Returning to FIG. 4, if it is determined, at operation 444, that τ is not greater than τₚ, then it is determined whether τ is less than τₚ, at operation 330. If τ is less than τₚ then this is a hyperbolic direct transfer, and the upper and lower bounds are determined from Equation 21, X∈[1, X_{UB}], at operation 452. Otherwise, this is a parabolic direct transfer and it is determined that X=1 at operation 450.

The root(s) of Equation 12 are then solved with the one or two sets of upper and lower bounds computed from the steps above via fourth-order Householder iteration with clamping at operation 454. The root(s) are determined based on the bounds determined at operation 448, 450, or 452.

At operation 456, the initial and final velocities are determined for each root, X, via Equations 23-24. After X, corresponding to the root of Equation 12 is found from the fourth-order Householder iteration scheme with clamping at operation 454, the initial and final velocity vectors 458, \vec{v}₁ and \vec{v}₂, of the transfer trajectory can be determined via Equations 23 and 24 at operation 456.

$${\vec{v}}_{1} = {V}_{T} ( {\hat{l}}_{h} \times {\hat{r}}_{1} ) + [ \vert σ \vert Y ( 1 - ρ ) - X ( 1 + ρ ) ] γ {\hat{r}}_{1} / \vert {\vec{r}}_{1} \vert \qquad Equation 23$$

$${\vec{v}}_{2} = {V}_{T} ( {\hat{l}}_{h} \times {\hat{r}}_{2} ) + [ \vert σ \vert Y ( 1 + ρ ) - X ( 1 - ρ ) ] γ {\hat{r}}_{2} / \vert {\vec{r}}_{2} \vert \qquad Equation 24$$

where Y is a function of X and σ via Equation 7 and:

$$γ = 1 / 2 \sqrt{μm} \qquad Equation 25$$

$$ρ = 1 / l ( \vert {\vec{r}}_{1} \vert - \vert {\vec{r}}_{2} \vert ) \qquad Equation 26$$

$${\hat{l}}_{h} = {\hat{r}}_{1} \times {\hat{r}}_{2} \qquad Equation 27$$

$${V}_{T} = γ \sqrt{1 - {ρ}^{2}} ( Y + \vert σ \vert X ) \qquad Equation 28$$

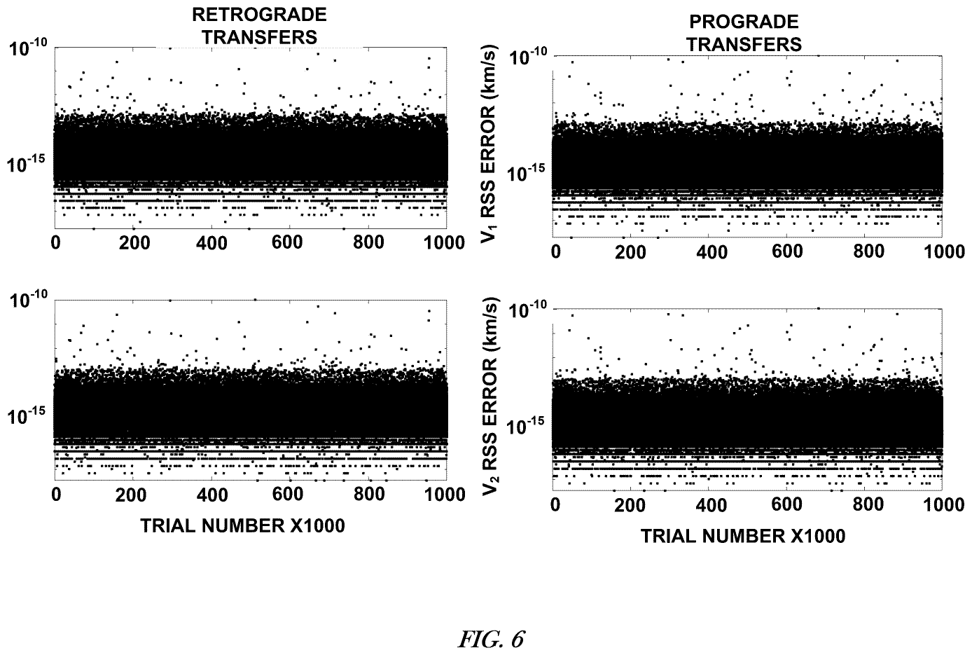

A software implementation of the method 400 was tested against a multi-revolution solver contained within pykep. pykep is a scientific library developed at the European Space Agency to provide basic tools for astrodynamics research. Earth's standard gravitational parameter of μ=398600.4418 km³ s⁻² is used for the central body while 1,000,000 random trajectories and times of flight were generated with only direct transfers permitted (e.g., single revolution solutions). The minimum and maximum permitted ranges from Earth were 6,800 km and 50,000 km, respectively. The time of flight was varied between 100 seconds and 100 days. The absolute and relative error tolerances were set to ϵ=10⁻¹⁵, while the maximum number of iterations were permitted to be 5. The algorithm performance for both prograde and retrograde transfers were then evaluated against pykep. The method 400 outperformed pykep for both prograde and retrograde transfer directions with average speedup performance between 5 and 20%. FIG. 6 illustrates, by way of example, graphs of the errors of the prograde and retrograde transfer simulations.

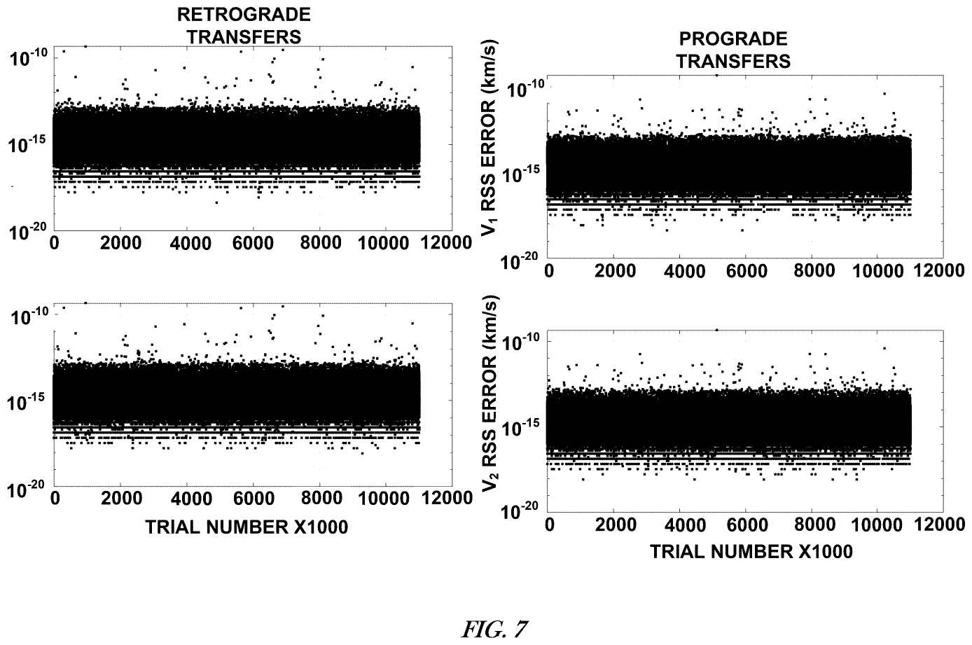

FIG. 7 illustrates, by way of example, graphs of the errors of the prograde and retrograde transfer simulations for multi-revolution transfer cases. For the simulations represented by FIG. 7, another million cases were run with the same parameter configuration as above, this time with a maximum of 5 revolutions permitted (e.g. Nₘₐₓ=5). Similarly, the new algorithm average runtimes outperformed pykep between 3 and 6%.

The method 400 provides a technique to bound Lambert's equation such that a solution is guaranteed not to jump between low and high-paths using a bracketing strategy in combination with a Householder's fourth-order root finding method. This method 400 has been demonstrated to perform exceptionally well on all conic cases which include elliptical, parabolic, and hyperbolic transfers. Multiple-revolution elliptical transfers including hundreds of revolutions have been simulated with mean relative velocity RSS errors below 10⁻¹⁰ km/s. The average computational efficiency of using this new method features an additional 20% improvement in runtimes over other state of the art Lambert solvers such as those used by pykep.

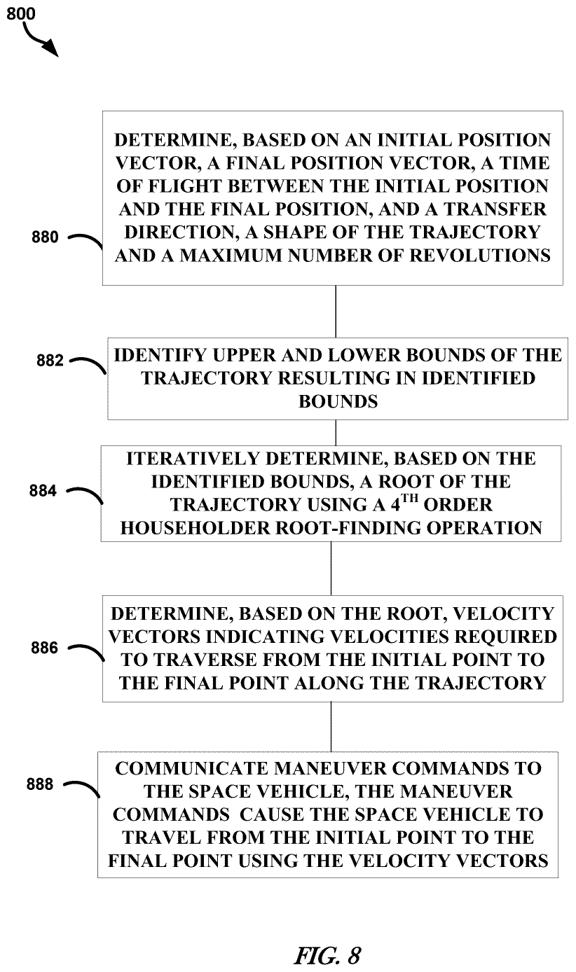

FIG. 8 illustrates, by way of example, a diagram of an embodiment of a method 800 for space vehicle management using a fourth-order Householder with clamping. The method 800 includes determining a trajectory between an initial point and a final point, the initial point and the final points on different orbits about a central body. The method 800 as illustrated includes determining, based on an initial position vector, a final position vector, a time of flight between the initial position and the final position, and a transfer direction, a shape of the trajectory and a maximum number of revolutions, at operation 880; identifying upper and lower bounds of the trajectory resulting in identified bounds, at operation 882; iteratively determining, based on the identified bounds, a root of the trajectory using a 4^{th} order Householder root-finding operation, at operation 884; determining, based on the root, velocity vectors indicating velocities required to traverse from the initial point to the final point along the trajectory, at operation 886; and communicating, by a transceiver of the device, maneuver commands to the space vehicle, the maneuver commands cause the space vehicle to travel from the initial point to the final point using the velocity vectors, at operation 888.

The operation 884 can include comparing a first root determined in a first iteration of the 4^{th} order Householder root-finding operation to the identified bounds. The operation 884 can include clamping the root to one of the identified bounds responsive to determining the first root is not within the identified bounds resulting in a clamped root. The operation 884 can include running another iteration of the 4^{th} order Householder root-finding operation based on the clamped root.

The method 800 can further include determining an approximation of a root based on the identified bounds. A first iteration of the 4^{th} order Householder root-finding operation can operate based on the approximation of the root. The approximation of the root can be an average of the identified bounds.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules may provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus (e.g., a programmable processor, a computer, or multiple computers).

A computer program may be written in any form of programming language, including compiled or interpreted languages, and it may be deployed in any form, including as a standalone program or as a module, subroutine, or other unit suitable for use in a computing environment. A computer program may be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations may also be performed by, and apparatus of example embodiments may be implemented as, special purpose logic circuitry, e.g., a field programmable gate array (FPGA) or an application-specific integrated circuit (ASIC).

The computing system may include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium (e.g., Storage Device)

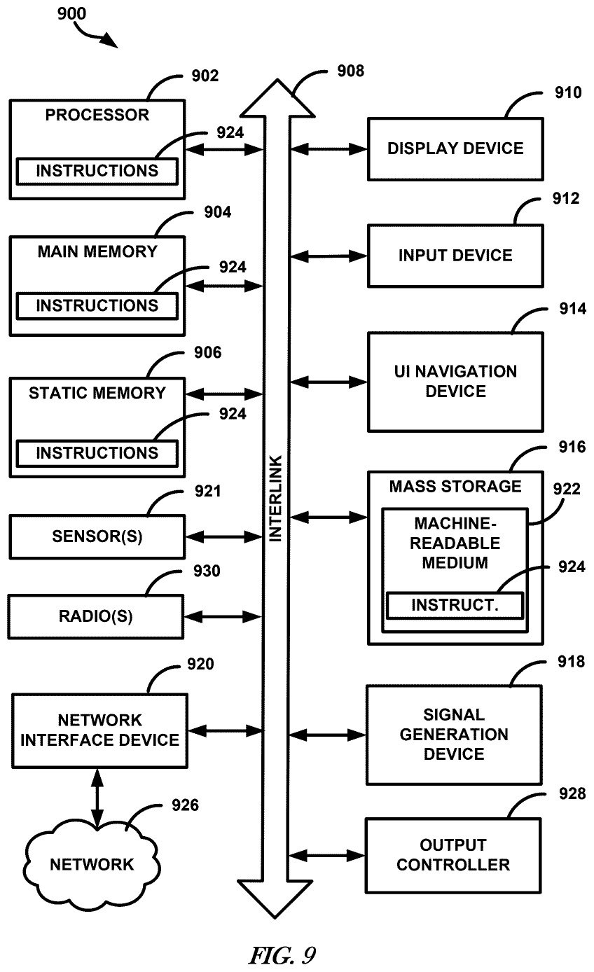

FIG. 9 illustrates, by way of example, a block diagram of an embodiment of a machine in the example form of a computer system 900 within which instructions, for causing the machine to perform any one or more of the methodologies discussed herein, may be executed. One or more of the operations of the method 400 can be implemented or performed by the computer system 900. A device, such as the ground station 134, in communication with the space vehicle 132, the space vehicle 132, or the like, can include one or more components of the computer system 900. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., processing circuitry, such as can include a central processing unit (CPU), a graphics processing unit (GPU), field programmable gate array (FPGA), other circuitry, such as one or more transistors, resistors, capacitors, inductors, diodes, regulators, switches, multiplexers, power devices, logic gates (e.g., AND, OR, XOR, negate, etc.), buffers, memory devices, sensors 921 (e.g., a transducer that converts one form of energy (e.g., light, heat, electrical, mechanical, or other energy) to another form of energy), such as an IR, SAR, SAS, visible, or other image sensor, or the like, or a combination thereof), or the like, or a combination thereof), a main memory 904 and a static memory 906, which communicate with each other via a bus 908. The memory 904, 906 can store parameters (sometimes called weights) that define operations of the processing circuitry 902, or other component of the system 900. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation device 914 (e.g., a mouse), a disk drive unit 916, a signal generation device 918 (e.g., a speaker), a network interface device 920, and radios 930 such as Bluetooth, WWAN, WLAN, and NFC, permitting the application of security controls on such protocols.

The machine 900 as illustrated includes an output controller 928. The output controller 928 manages data flow to/from the machine 900. The output controller 928 is sometimes called a device controller, with software that directly interacts with the output controller 928 being called a device driver.

### Machine-Readable Medium

The disk drive unit 916 includes a machine-readable medium 922 on which is stored one or more sets of instructions and data structures (e.g., software) 924 embodying or utilized by any one or more of the methodologies or functions described herein. The instructions 924 may also reside, completely or at least partially, within the main memory 904, the static memory 906, and/or within the processor 902 during execution thereof by the computer system 900, the main memory 904 and the processor 902 also constituting machine-readable media.

While the machine-readable medium 922 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 924 may further be transmitted or received over a communications network 926 using a transmission medium. The instructions 924 may be transmitted using the network interface device 920 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible media to facilitate communication of such software.

### Additional Example

Example 1 can include a device comprising a transceiver configured to communicate with a space vehicle, and processing circuitry configured to determine a trajectory between an initial point and a final point, the initial point and the final points on different orbits about a central body, by determining, based on an initial position vector, a final position vector, a time of flight between the initial position and the final position, and a transfer direction, a shape of the trajectory and a maximum number of revolutions, identifying upper and lower bounds of the trajectory resulting in identified bounds, iteratively determining, based on the identified bounds, a root of the trajectory using a 4^{th} order Householder root-finding operation, determining, based on the root, velocity vectors indicating velocities required to traverse from the initial point to the final point along the trajectory, and communicate maneuver commands to the space vehicle, the maneuver commands cause the space vehicle to travel from the initial point to the final point using the velocity vectors.

In Example 2, Example 1 further includes, wherein iteratively determining the root of the trajectory using a 4^{th} order Householder root-finding operation includes comparing a first root determined in a first iteration of the 4^{th} order Householder root-finding operation to the identified bounds.

In Example 3, Example 2 further includes, wherein iteratively determining the root of the trajectory using a 4^{th} order Householder root-finding operation includes clamping the root to one of the identified bounds responsive to determining the first root is not within the identified bounds resulting in a clamped root.

In Example 4, Example 3 further includes, wherein iteratively determining the root of the trajectory using a 4^{th} order Householder root-finding operation includes running another iteration of the 4^{th} order Householder root-finding operation based on the clamped root.

In Example 5, at least one of Examples 1-4 further includes, wherein the processing circuitry is further configured to determine an approximation of a root based on the identified bounds.

In Example 6, Example 5 further includes, wherein a first iteration of the 4^{th} order Householder root-finding operation operates based on the approximation of the root.

In Example 7, Example 6 further includes, wherein the approximation of the root is an average of the identified bounds.

Example 8 includes a method comprising determining, by processing circuitry of a device, a trajectory between an initial point and a final point, the initial point and the final points on different orbits about a central body, by determining, based on an initial position vector, a final position vector, a time of flight between the initial position and the final position, and a transfer direction, a shape of the trajectory and a maximum number of revolutions, identifying upper and lower bounds of the trajectory resulting in identified bounds, iteratively determining, based on the identified bounds, a root of the trajectory using a 4^{th} order Householder root-finding operation, determining, based on the root, velocity vectors indicating velocities required to traverse from the initial point to the final point along the trajectory, and communicating, by a transceiver of the device, maneuver commands to the space vehicle, the maneuver commands cause the space vehicle to travel from the initial point to the final point using the velocity vectors.

In Example 9, Example 8 further includes, wherein iteratively determining the root of the trajectory using a 4^{th} order Householder root-finding operation includes comparing a first root determined in a first iteration of the 4^{th} order Householder root-finding operation to the identified bounds.

In Example 10, Example 9 further includes, wherein iteratively determining the root of the trajectory using a 4^{th} order Householder root-finding operation includes clamping the root to one of the identified bounds responsive to determining the first root is not within the identified bounds resulting in a clamped root.

In Example 11, Example 10 further includes, wherein iteratively determining the root of the trajectory using a 4^{th} order Householder root-finding operation includes running another iteration of the 4^{th} order Householder root-finding operation based on the clamped root.

In Example 12, at least one of Examples 8-11 further includes determining an approximation of a root based on the identified bounds.

In Example 13, Example 12 further includes, wherein a first iteration of the 4^{th} order Householder root-finding operation operates based on the approximation of the root.

In Example 14, Example 13 further includes, wherein the approximation of the root is an average of the identified bounds.

Example 15 includes a non-transitory machine-readable medium including instructions that, when executed by a machine, cause the machine to perform operations of causing a space vehicle to maneuver between an initial point and a final point, the operations comprising the method of one of Examples 8-14.

Although teachings have been described with reference to specific example teachings, it will be evident that various modifications and changes may be made to these teachings without departing from the broader spirit and scope of the teachings. Accordingly, the specification and drawings are to be regarded in an illustrative rather than a restrictive sense. The accompanying drawings that form a part hereof, show by way of illustration, and not of limitation, specific teachings in which the subject matter may be practiced. The teachings illustrated are described in sufficient detail to enable those skilled in the art to practice the teachings disclosed herein. Other teachings may be utilized and derived therefrom, such that structural and logical substitutions and changes may be made without departing from the scope of this disclosure. This Detailed Description, therefore, is not to be taken in a limiting sense, and the scope of various teachings is defined only by the appended claims, along with the full range of equivalents to which such claims are entitled.

What is claimed is:

1. A device comprising:
a transceiver configured to communicate with a space vehicle; and
processing circuitry configured to:
determine a trajectory between an initial point and a final point, the initial point and the final points on different orbits about a central body, by:
determining, based on an initial position vector, a final position vector, a time of flight between the initial position and the final position, and a transfer direction, a shape of the trajectory and a maximum number of revolutions;
identifying upper and lower bounds of the trajectory resulting in identified bounds;
iteratively determining, based on the identified bounds, a root of the trajectory using a 4^{th} order Householder root-finding operation;
determining, based on the root, velocity vectors indicating velocities required to traverse from the initial point to the final point along the trajectory; and
communicate maneuver commands to the space vehicle, the maneuver commands cause the space vehicle to travel from the initial point to the final point using the velocity vectors.

2. The device of claim 1, wherein iteratively determining the root of the trajectory using a 4^{th} order Householder root-finding operation includes comparing a first root determined in a first iteration of the 4^{th} order Householder root-finding operation to the identified bounds.

3. The device of claim 2, wherein iteratively determining the root of the trajectory using a 4^{th} order Householder root-finding operation includes clamping the root to one of the identified bounds responsive to determining the first root is not within the identified bounds resulting in a clamped root.

4. The device of claim 3, wherein iteratively determining the root of the trajectory using a 4^{th} order Householder root-finding operation includes running another iteration of the 4^{th} order Householder root-finding operation based on the clamped root.

5. The device of claim 1, wherein the processing circuitry is further configured to determine an approximation of a root based on the identified bounds.

6. The device of claim 5, wherein a first iteration of the 4^{th} order Householder root-finding operation operates based on the approximation of the root.

7. The device of claim 6, wherein the approximation of the root is an average of the identified bounds.

8. A method comprising:
determining, by processing circuitry of a device, a trajectory between an initial point and a final point, the initial point and the final points on different orbits about a central body, by:
determining, based on an initial position vector, a final position vector, a time of flight between the initial position and the final position, and a transfer direction, a shape of the trajectory and a maximum number of revolutions;
identifying upper and lower bounds of the trajectory resulting in identified bounds;
iteratively determining, based on the identified bounds, a root of the trajectory using a 4^{th} order Householder root-finding operation;
determining, based on the root, velocity vectors indicating velocities required to traverse from the initial point to the final point along the trajectory; and
communicating, by a transceiver of the device, maneuver commands to a space vehicle, the maneuver commands cause the space vehicle to travel from the initial point to the final point using the velocity vectors.

9. The method of claim 8, wherein iteratively determining the root of the trajectory using a 4^{th} order Householder root-finding operation includes comparing a first root determined in a first iteration of the 4^{th} order Householder root-finding operation to the identified bounds.

10. The method of claim 9, wherein iteratively determining the root of the trajectory using a 4^{th} order Householder root-finding operation includes clamping the root to one of the identified bounds responsive to determining the first root is not within the identified bounds resulting in a clamped root.

11. The method of claim 10, wherein iteratively determining the root of the trajectory using a 4^{th} order Householder root-finding operation includes running another iteration of the 4^{th} order Householder root-finding operation based on the clamped root.

12. The method of claim 8, further comprising determining an approximation of a root based on the identified bounds.

13. The method of claim 12, wherein a first iteration of the 4^{th} order Householder root-finding operation operates based on the approximation of the root.

14. The method of claim 13, wherein the approximation of the root is an average of the identified bounds.

15. A non-transitory machine-readable medium including instructions that, when executed by a machine, cause the machine to perform operations of causing a space vehicle to maneuver between an initial point and a final point, the operations comprising:
determining a trajectory between an initial point and a final point, the initial point and the final points on different orbits about a central body, by:
determining, based on an initial position vector, a final position vector, a time of flight between the initial position and the final position, and a transfer direction, a shape of the trajectory and a maximum number of revolutions;
identifying upper and lower bounds of the trajectory resulting in identified bounds;
iteratively determining, based on the identified bounds, a root of the trajectory using a 4^{th} order Householder root-finding operation;
determining, based on the root, velocity vectors indicating velocities required to traverse from the initial point to the final point along the trajectory; and
communicating maneuver commands to the space vehicle, the maneuver commands cause the space vehicle to travel from the initial point to the final point using the velocity vectors.

16. The non-transitory machine-readable medium of claim 15, wherein iteratively determining the root of the trajectory using a 4^{th} order Householder root-finding operation includes comparing a first root determined in a first iteration of the 4^{th} order Householder root-finding operation to the identified bounds.

17. The non-transitory machine-readable medium of claim 16, wherein iteratively determining the root of the trajectory using a 4^{th} order Householder root-finding operation includes clamping the root to one of the identified bounds responsive to determining the first root is not within the identified bounds resulting in a clamped root.

18. The non-transitory machine-readable medium of claim 17, wherein iteratively determining the root of the trajectory using a 4^{th} order Householder root-finding operation includes running another iteration of the 4^{th} order Householder root-finding operation based on the clamped root.

19. The non-transitory machine-readable medium of claim 15, wherein the operations further comprise determining an approximation of a root based on the identified bounds.

20. The non-transitory machine-readable medium of claim 19, wherein a first iteration of the 4^{th} order Householder root-finding operation operates based on the approximation of the root.
